(19) United States
(12) Patent Application Publication
(10) Pub. No.: US 2002/0160344 A1
(43) Pub. Date: Oct. 31, 2002

(54) Self-ordering and recall testing system and method

(76) Inventor: David Tulsky, Summit, NJ (US)

Correspondence Address: Allen, Dyer, Doppelt, Milbrath & Gilchrist, P.A., 255 South Orange Avenue, Suite 1401, P.O. Box 3791, Orlando, FL, 32802-3791, US

(21) Appl. No.: 10/123,038

(22) Filed: Apr. 15, 2002

Related U.S. Application Data
(60) Provisional application No. 60/285,951, filed on Apr. 24, 2001.

(51) Int. Cl. G09B 19/00

(52) U.S. Cl. 434/236; 434/322; 434/323; 273/273

(57) ABSTRACT

A method for testing a working memory of a subject includes the steps of presenting to a subject a first representation of a plurality of items and asking the subject to select a first item from the first representation. Next the subject is presented with a second representation of the plurality of items and is asked to select a second item from the second representation, the second item different from the first item. These steps test a subject's ability to select a different item from a plurality thereof, a first type of information. As a next aspect of the test the subject is asked to recall an order of the selected items. This step requires the subject to track the order of selection, another type of information. This juxtaposition of testing aspects increases the working memory load on the subject.

### CROSS-REFERENCE TO RELATED APPLICATION

This application claims priority to provisional application 60/285,951, “Self-Ordering and Recall Testing System and Method,” filed Apr. 24, 2001.

### BACKGROUND OF THE INVENTION

1. Field of the Invention

The present invention relates to systems and methods for testing intelligence, and, more particularly, to such system and methods for testing working memory.

2. Description of Related Art

Tests are known in the art for testing recall, including those that present a series of images to the user for subsequent recall (Barens, U.S. Pat. No. 2,359,460; Heller, U.S. Pat. No. 3,755,921; Mirando U.S. Pat. No. 5,411,271). It is also known to present tones (Morrison et al. U.S. Pat. No. 4,207,087) and other data or codes (Buschke, U.S. Pat. No. 4,770,636; Keller, U.S. Pat. No. 5,079,726).

However, there are no tests known in the art that also require an additional memory dimension imposed by self-ordering.

### SUMMARY OF THE INVENTION

It is therefore an object of the present invention to provide a system and method for testing a user's recall.

It is a further object to provide such a system and method for testing recall in two dimensions.

It is also an object to provide such a system and method for providing for adaptive administration of a test.

It is another object to provide a method for scoring such a test.

It is an additional object to provide a method for administering such a test.

It is yet a further object to provide a series of representations for use in such a test.

These and other objects are achieved by the present invention, a method for testing a working memory of a subject. The method comprises the steps of presenting to a subject a first representation of a plurality of items and asking the subject to select a first item from the first representation. Next the subject is presented with a second representation of the plurality of items and is asked to select a second item from the second representation, the second item different from the first item. These steps test a subject's ability to select a different item from a plurality thereof, a first type of information.

A next aspect of the test comprises the step of asking the subject to recall an order of the selected items. This step requires the subject to track the order of selection, another type of information. This juxtaposition of testing aspects increases the working memory load on the subject.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIGS. 1A,1B is a flowchart outlining an administration of a test of working memory of the present invention.

FIGS. 2A-2E is an exemplary series of picture cards, including four selection cards (FIGS. 3A-3D) and a recall card (FIG. 3E).

FIGS. 3A,3B are schematic diagrams of a manual (FIG. 3A) and an automated (FIG. 3B) system for administering a test.

### DETAILED DESCRIPTION OF THE PREFERRED EMBODIMENTS

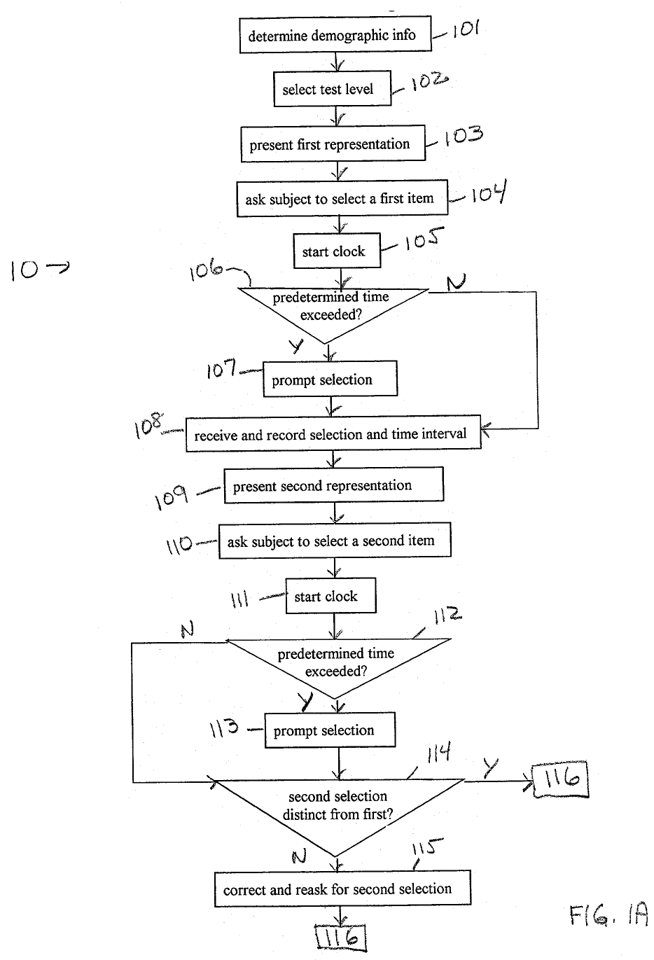

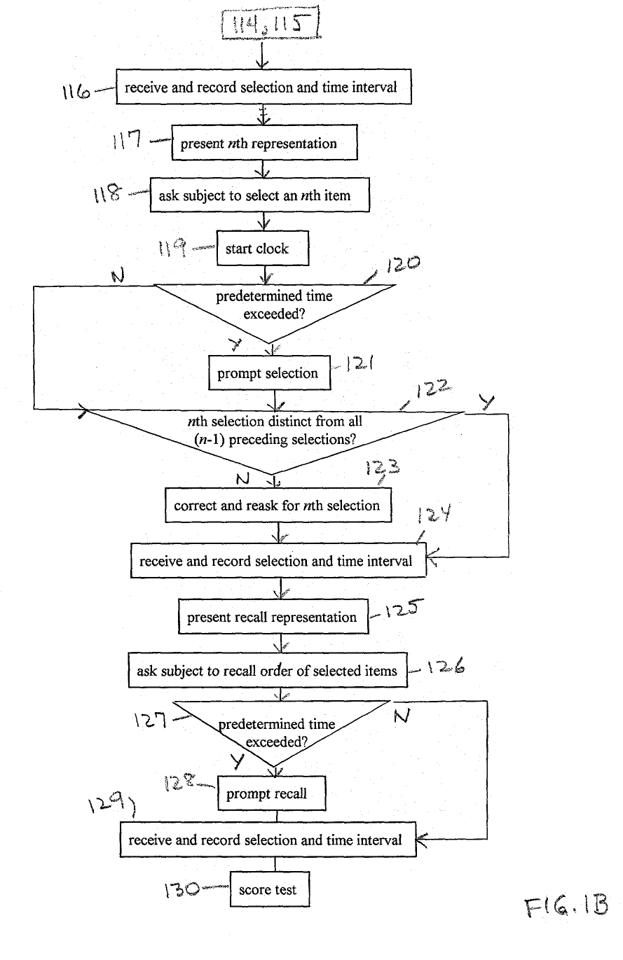

A description of the preferred embodiments of the present invention will now be presented with reference to FIGS. 1A-3B.

An exemplary flowchart of the test administration method (FIGS. 1A, 1B) outlines steps to be taken in giving the self-ordering and recall test 10, which is intended to test a working memory of a subject 20. The method comprises the steps of determining demographic information on the subject 20 (block 101) for the purpose of choosing an appropriate test level (block 102) to be presented. Such demographic information typically includes, but is not intended to be limited to, the subject's age and/or grade level.

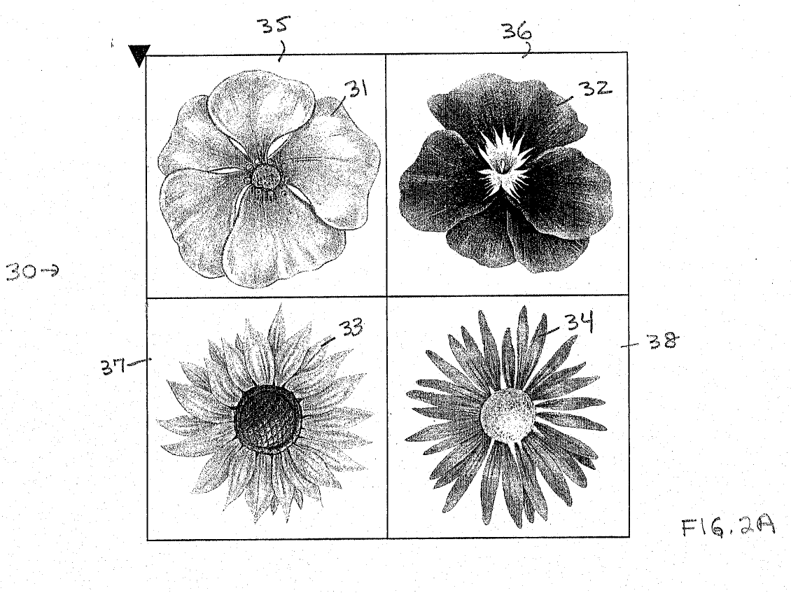

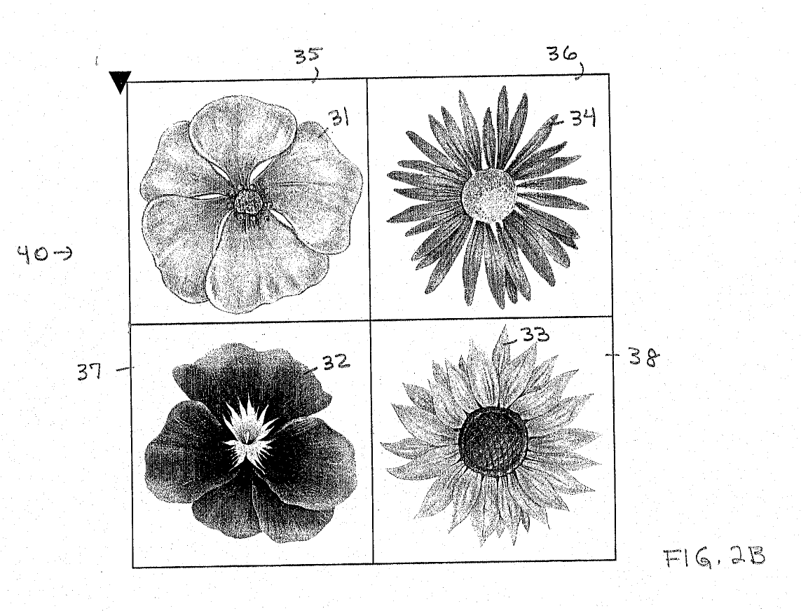

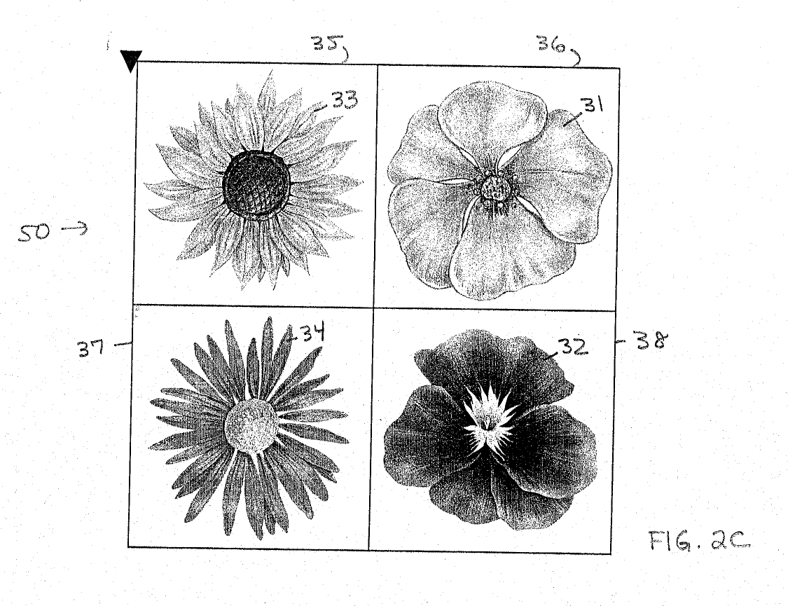

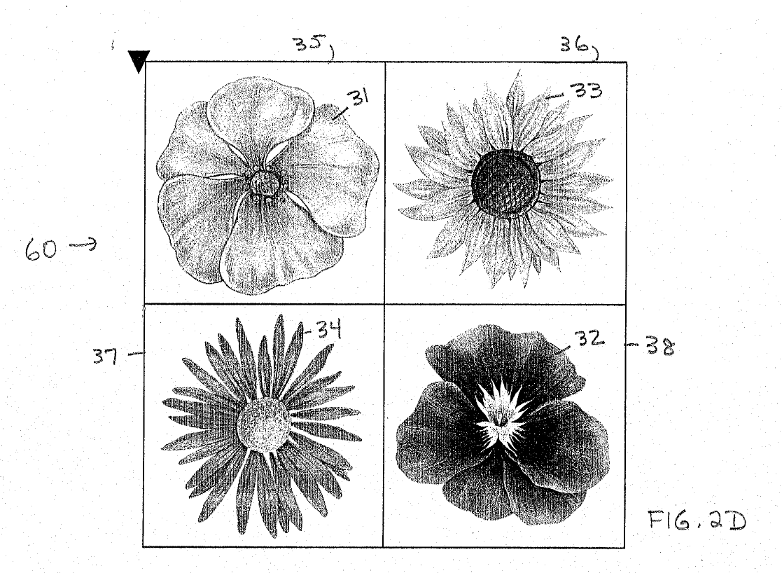

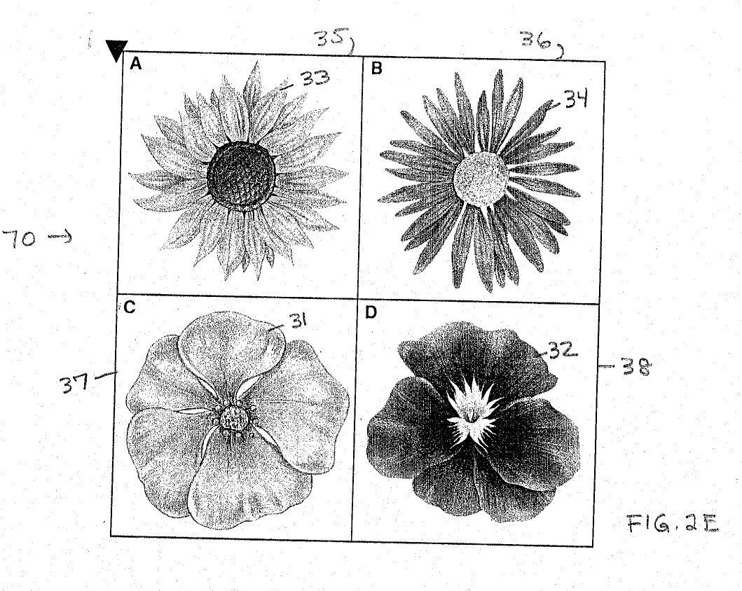

Next the subject 20 is presented with a first representation of a plurality of items (block 103). In a first embodiment, this first representation comprises a card or sheet of paper with a collection of different pictures thereon. An exemplary first representation 30 is given in FIG. 2A, wherein four pictures of different flowers 31-34 are given in a first orientation, with the flowers 31-34 placed in four positions 35-38.

Next the subject 20 is asked to select a first item from the first representation 30 (block 104), and he or she selects, say, for example, item 31. The interval between the asking and the making of the selection may be timed in a particular embodiment (block 105). If a predetermined interval has been exceeded between the asking and the selecting steps (block 106), the subject 20 is prompted, for example, verbally by the test giver 21 to make a selection (block 107). The test giver 21 records the first selection 31 and the first elapsed time on a form (block 108).

The subject 20 is then presented with a second representation 40 of the plurality of items (FIG. 2B, block 109), with the flowers 31-34 in the positions, respectively, 31,34,32,33. The subject 20 is then asked to select a second item from the second representation 40 (block 110), with the second item, say, second selection 32, being different from the first item. Again, the second elapsed time is calculated (block 111), with prompting given (block 113) if a predetermined interval is exceeded (block 112). If the subject 20 errs and attempts to select the same item 31 (block 114), he/she is corrected and asked to reselect a second item (block 115). The selection and time elapsed are recorded (block 116).

This process is repeated n times (blocks 117-124), where n is the number of items on the representations. Here, the flowers 31-34 appear on four cards 30,40,50,60 (FIGS.2A-2D) in four different orientations.

When all items 31-34 have been selected, the subject 20 is presented with a fifth representation 70 of the items on a “recall card” 125 and is asked to recall an order of the selected items (block 126). Again, if a predetermined time is exceeded by the subject 20 (block 127), prompting is given (block 128). Once the test 10 has been completed and recorded (block 129), the form is scored (block 130). The score is indicative of a working memory of the subject 20.

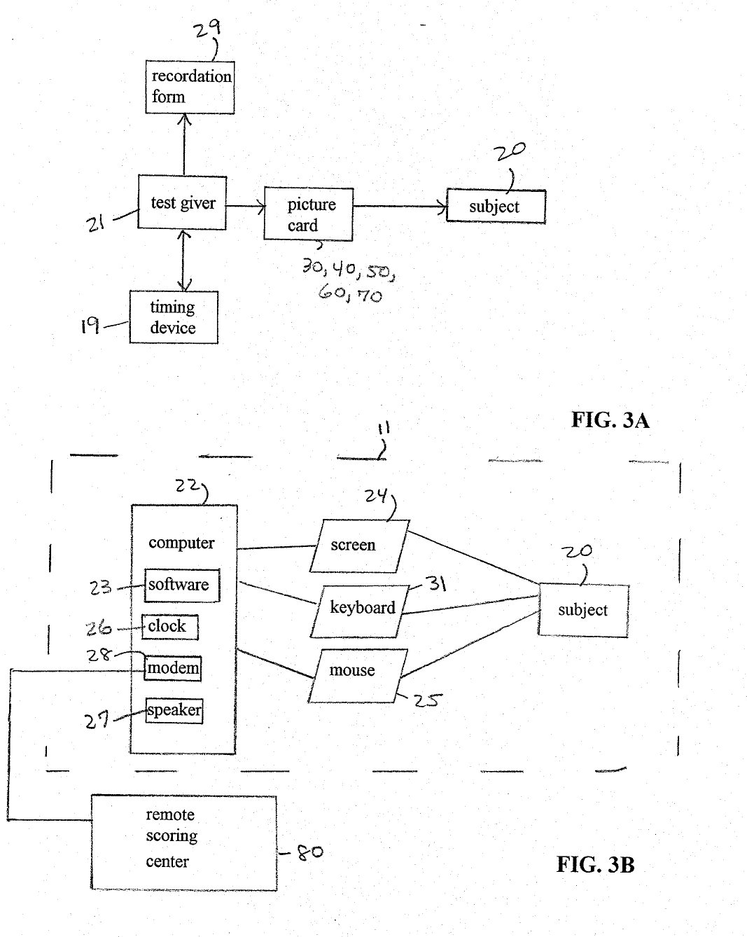

One of skill in the art will recognize that a “manual” or “automated” test administration mode may be contemplated. In a manual mode (FIG. 3A), picture cards 30,40,50,60,70 such as those illustrated in FIGS. 2A-2E are shown to the subject 20 by a human test giver 21, who also manually records the times 19 and responses on a form 29. Scoring may be done either by the test giver 21 or by another entity, such as a testing corporation or computer.

In an automated embodiment (FIG. 3B), the “test giver” comprises a computer 22 having resident thereon a software package 23 adapted to give the test in substantially the same steps as listed above. In communication with and under direction from the computer 22 is a display screen 24, on which may be presented the representations and which, using a keyboard 31 or a pointing device such as a mouse 25 in communication with the computer 22, the subject 20 may make selections. Other forms of receiving communication from the subject 20 may comprise such devices known in the art as a touch screen or a microphone for voice recognition and translation, and the invention is not intended to be limited to particular input/output devices.

The computer 22 further comprises a clock 26 accessible by the software 23 for performing the timing functions. In this automated case, the prompting and asking steps can be performed by displaying a statement or query on the screen 24, or via a speaker 27 in communication with the computer 22, under direction of the software 23.

Scoring in this case could be performed by the software 23 resident in the computer 20. Alternatively, the digital “scoring form,” a data record, may be transmitted via modem 28 to a scoring center 80 remote from the test site 11.

This software 23 also permits adaptive administration of tests, which is difficult to perform manually. In adaptive administration, a contemporaneous evaluation by the software 23 of the subject's performance allows a presentation of subsequent portions of the test based upon the analyzed performance to that point.

It may be appreciated by one skilled in the art that additional embodiments may be contemplated, including alternate representations of items and alternate modes of presenting the items to a subject.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiment thereof, and the advantageous new and useful results obtained thereby, the new and useful constructions, and reasonable mechanical equivalents thereof obvious to those skilled in the art, are set forth in the appended claims.

What is claimed is:

1. A method for testing a working memory of a subject, the method comprising the steps of:
presenting to a subject a first representation of a plurality of items;
asking the subject to select a first item from the first representation;
presenting to the subject a second representation of the plurality of items;
asking the subject to select a second item from the second representation, the second item different from the first item; and
asking the subject to recall an order of the selected items.

2. The method recited in claim 1, further comprising the step of asking the subject to select additional items from the plurality of items, each selected item comprising an item not previously selected, until all the items have been selected.

3. The method recited in claim 1, further comprising the step of timing each of the asking steps.

4. The method recited in claim 3, further comprising the step of prompting the subject if a predetermined time has been exceeded without receiving a response.

5. The method recited in claim 1, further comprising the step, preceding the recall asking step, of presenting to the subject a third representation of the plurality of items.

6. The method recited in claim 1, further comprising the steps, following the second item subject asking step, of, if the subject selects a second item that is equivalent to the first item, correcting the subject and reasking the subject to select a second item from the second representation.

7. The method recited in claim 1, further comprising the step of recording the selections on a scoring form.

8. The method recited i n claim 7, further comprising the step, following the recall asking step, of scoring the scoring form to determine a working memory indicator.

9. The method recited in claim 1, wherein the second representation is different from the first representation.

10. The method recited in claim 1, wherein the first and the second representation each comprises a card having a plurality of pictures thereon, each picture distinct from each other picture.

11. The method recited in claim 1, wherein the first and the second representation each comprises means for displaying a screen having a plurality of pictures thereon, each picture distinct from each other picture.

12. A system for testing a working memory of a subject, the system comprising:
a first representation of a plurality of items;
means for asking the subject to select a first item from the first representation;
a second representation of the plurality of items;
means for asking the subject to select a second item from the second representation, the second item different from the first item; and
means for asking the subject to recall an order of the selected items.

13. The system recited in claim 12, further comprising means for asking the subject to select additional items from the plurality of items, each selected item comprising an item not previously selected, until all the items have been selected.

14. The system recited in claim 12, further comprising means for timing each of the asking steps.

15. The system recited in claim 14, further comprising means for prompting the subject if a predetermined time has been exceeded without receiving a response.

16. The system recited in claim 12, further comprising a third representation of the plurality of items.

17. The system recited in claim 12, further comprising means for, if the subject selects a second item that is equivalent to the first item, correcting the subject and means for reasking the subject to select a second item from the second representation.

18. The system recited in claim 12, further comprising a scoring form.

19. The system recited in claim 18, further comprising means for scoring the scoring form to determine a working memory indicator.

20. The system recited in claim 12, wherein the second representation is different from the first representation.

21. The system recited in claim 12, wherein the first and the second representation each comprises a card having a plurality of pictures thereon, each picture distinct from each other picture.

22. The system recited in claim 12, wherein the first and the second representation each comprises means for displaying a screen having a plurality of pictures thereon, each picture distinct from each other picture.

23. A system for testing a working memory of a subject, the system comprising:
a processor;
a display screen and an input device, each in electronic communication with the processor;
software means resident in the processor adapted to:
display to a subject a first representation of a plurality of items on the screen;
ask the subject to select a first item from the first representation via the input device;
display to the subject a second representation of the plurality of items on the screen;
ask the subject to select a second item from the second representation, the second item different from the first item, via the input device; and
ask the subject to enter via the input device an order of the selected items.

24. The system recited in claim 23, further comprising means for the subject to enter via the input device a desired testing level, and wherein the software means is further adapted to display a first and a second representation commensurate with the desired testing level.

25. The system recited in claim 23, wherein:
the processor comprises a clock; and
the software means is further adapted to calculate and record a time difference between a displaying of the second representation and a selection by the subject of a second item.

26. The system recited in claim 23, wherein the software means is adapted to display a first representation different from a second representation.
